(19) United States
(12) Patent Application Publication
(10) Pub. No.: US 2024/0157679 A1
(43) Pub. Date: May 16, 2024

(54) GLASS LAMINATE ARTICLE AND ADHESIVE COMPOSITION FOR THE SAME

(71) Applicants: CORNING INCORPORATED, Corning, NY (US); CHO KWANG PAINT CO., LTD., Busan (KR)

(72) Inventors: Jong Won Ha, Busan (KR); Jhee-mann Kim, Yongin-Si (KR); Goo Soo Lee, Songpa-gu (KR)

(21) Appl. No.: 18/282,345

(22) PCT Filed: Mar. 18, 2022
(86) PCT No.: PCT/US2022/020921

§ 371 Date: Sep. 15, 2023

(30) Foreign Application Priority Data
Mar. 18, 2021 (KR) 10-2021-0035242

(51) Int. Cl. B32B 17/06; B32B 7/12; B32B 15/18; C08F 220/18; C09J 4/00; C09J 133/06

(52) U.S. Cl. CPC B32B 17/061; B32B 7/12; B32B 15/18; C08F 220/1811; C09J 4/00; C09J 133/062; C09J 133/066; B32B 2255/26; B32B 2255/28; B32B 2307/412; B32B 2307/54; B32B 2307/712; B32B 2307/748; C08F 2800/20

(57) ABSTRACT

A glass laminate article includes: a resin layer provided on a first surface of a core substrate; and a glass substrate layer provided on the resin layer, wherein the resin layer has an initial modulus of 30 MPa to 250 MPa, the initial modulus being measured in a deformation range of 0.5% to 1.0%.

### CROSS-REFERENCE TO RELATED APPLICATION

This application is based on and claims priority under 35 U.S.C. § 119 to Korean Patent Application No. 10-2021-0035242, filed on Mar. 18, 2021, in the Korean Intellectual Property Office, the disclosure of which is incorporated by reference herein in its entirety.

### BACKGROUND

### 1. Field

The disclosure relates to a glass laminate article and an adhesive composition for the glass laminate article, and more particularly, to a glass laminate article capable of preventing delamination of glass and maintaining a high level of flatness, and an adhesive composition for the glass laminate article.

### 2. Description of the Related Art

In order to apply heterogeneous materials to building materials and furniture materials, it may be necessary that properties do not change significantly despite changes in the surrounding environment. In particular, in order to employ a glass substrate, it is necessary to stabilize various characteristics while maintaining a beautiful appearance.

### SUMMARY

Provided is a glass laminate article capable of preventing delamination of glass and maintaining a high level of flatness.

Provided is an adhesive composition for a glass laminate article capable of preventing delamination of glass and maintaining a high level of flatness.

Additional aspects will be set forth in part in the description which follows and, in part, will be apparent from the description, or may be learned by practice of the presented embodiments of the disclosure.

According to an aspect of the disclosure, a glass laminate article includes a resin layer provided on a first surface of a core substrate, and a glass substrate layer provided on the resin layer, wherein the resin layer has an initial modulus of 30 MPa to 250 MPa, the initial modulus being measured in a deformation range of 0.5% to 1.0%.

In some embodiments, the resin layer may include ultraviolet curable (meth)acrylate resin having a number-averaged molecular weight of 5,000 to 3,000,000.

In some embodiments, the resin layer may include a polymerization product of an ultraviolet curable (meth)acrylate oligomer and a monofunctional or multifunctional acryl monomer, the ultraviolet curable (meth)acrylate oligomer may be urethane (meth)acrylate based, and the urethane (meth)acrylate-based oligomer may be produced by obtaining an isocyanate group-containing compound by reacting polyol with diisocyanate in an equivalent ratio of 1:1 to 1:1.2, and reacting the isocyanate group-containing compound with (meth)acrylate containing a hydroxy group.

In some embodiments, the resin layer may include a polymerization product of an ultraviolet curable (meth)acrylate oligomer and a monofunctional or multifunctional acryl monomer, the ultraviolet curable (meth)acrylate oligomer may be ester (meth)acrylate based, and the ester (meth)acrylate-based oligomer may be produced by obtaining polyester by a dehydration and condensation reaction of polyhydric alcohol and polybasic acid, and reacting the polyester with at least one of (meth)acryl acid, hydroxyalkyl(meth)acrylate, and polyalkylene glycol mono(meth)acrylate.

In some embodiments, the resin layer may include a polymerization product of an ultraviolet curable (meth)acrylate oligomer and a monofunctional or multifunctional acryl monomer, the ultraviolet curable (meth)acrylate oligomer may be ester (meth)acrylate-based, and the ester (meth)acrylate-based oligomer may be produced by mixing and reacting polyhydric alcohol and polybasic acid with at least one of (meth)acryl acid, hydroxyalkyl(meth)acrylate, and polyalkylene glycol mono(meth)acrylate.

In some embodiments, the resin layer may include a polymerization product of an ultraviolet curable (meth)acrylate oligomer and a monofunctional or multifunctional acryl monomer, the ultraviolet curable (meth)acrylate oligomer may be acryl (meth)acrylate-based, and the acryl (meth)acrylate-based oligomer may be produced by obtaining an acryl polymer by polymerizing acryl monomers, and adding (meth)acryl acid or isocyanato(meth)acrylate to the acryl polymer.

In some embodiments, visible light transmittance of the resin layer may be 90% or more. In some embodiments, the glass laminate article may further include a first metal layer on a second surface opposite to the first surface of the core substrate.

According to another aspect of the disclosure, a glass laminate article includes a core substrate including a first surface, a second surface opposite to the first surface, and a side surface between the first surface and the second surface, a glass substrate provided on the first surface, an image layer between the first surface and the glass substrate, and an adhesive member provided between the glass substrate and the image layer, wherein the adhesive member includes ultraviolet curable (meth)acrylate resin, and the ultraviolet curable (meth)acrylate resin may be one or more selected from the group consisting of polyurethane (meth)acrylate, polyester (meth)acrylate, and polyacryl (meth)acrylate and has a number-averaged molecular weight of 5,000 to 3,000,000.

In some embodiments, an initial modulus of the adhesive member may be 30 MPa to 250 MPa. In some embodiments, the image layer may include a metal layer.

In some embodiments, the polyurethane (meth)acrylate may include a polymerization product of a urethane (meth)acrylate oligomer and a monofunctional or multifunctional acryl monomer.

In some embodiments, the polyester (meth)acrylate may include a polymerization product of an ester (meth)acrylate oligomer and a monofunctional or multifunctional acryl monomer.

In some embodiments, the polyacryl (meth)acrylate may include a polymerization product of an acryl (meth)acrylate oligomer and a monofunctional or multifunctional acryl monomer.

In some embodiments, the monofunctional or multifunctional acryl monomer may be one or more selected from the group consisting of n-butyl (meth)acrylate, 2-butyl (meth)acrylate, t-butyl (meth)acrylate, isobutyl (meth)acrylate, hexyl (meth)acrylate, 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, 2-methyl butyl (meth)acrylate, n-nonyl (meth)acrylate, isononyl (meth)acrylate, isoamyl (meth)acrylate, n-decyl (meth)acrylate, isodecyl (meth)acrylate, isobornyl (meth)acrylate, 4-methyl-2-pentyl (meth)acrylate, 3,3,5-trimethyl cyclohexyl (meth)acrylate, dodecyl (meth)acrylate, lauryl (meth)acrylate, 2-ethoxyethyl (meth)acrylate, 2-methoxyethyl (meth)acrylate, and allyl (meth)acrylate.

According to another aspect of the disclosure, an adhesive composition for a glass laminate article includes 100 parts by weight of an ultraviolet curable (meth)acrylate oligomer having a number-averaged molecular weight of 5,000 to 300,000, 100 parts by weight to 400 parts by weight of a monofunctional or multifunctional acryl monomer, 1 part by weight to 5 parts by weight of a photoinitiator, and 0.5 parts by weight to 3 parts by weight of an adhesion promotor, wherein the adhesive composition has a glass transition temperature (Tg) of −30° C. to 30° C., visible light transmittance of 90% or more, and an initial modulus of 10 MPa to 300 MPa when measured in a deformation range of 0.5% to 1.0% after cured by ultraviolet irradiation.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an exploded perspective view of a glass laminate article according to an embodiment of the disclosure;

FIG. 2 is a cross-sectional view taken along line II-II′ of the glass laminate article of FIG. 1;

FIG. 3 is an exploded perspective view of a glass laminate article according to another embodiment of the disclosure;

FIG. 4 is a cross-sectional view taken along line IV-IV′ of the glass laminate article of FIG. 3;

FIG. 5 is a flowchart showing a method of producing a glass laminate article, according to an embodiment of the disclosure;

FIGS. 6A to 6C are cross-sectional views showing the method of producing a glass laminate article of FIG. 5, step by step;

FIG. 7 shows images according to results of Corning Environment Evaluation #5 performed on GoS products produced by using the UV curable resin of Embodiment 1 and Comparative Example 5;

FIG. 8 shows images according to results of Corning Environment Evaluation #4 performed on GoHPL products produced by using the UV curable resin of Embodiment 6 and Comparative Example 1; and

FIG. 9 shows images according to results of Corning Environment Evaluations #1 to #4 performed on a GoSoMDF product produced by using the UV curable resin of Embodiment 10 and a GoSoMDF product to which a glass substrate is bonded by using OCA instead of the UV curable resin.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The disclosure will now be described more fully with reference to the accompanying drawings, in which embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those of ordinary skill in the art. Any one embodiment may be combined with another embodiment unless they are contradict each other. Also, a constituent element of any one embodiment may be combined with another embodiment unless they are contradict each other.

Like reference numerals denote like elements throughout. Furthermore, various elements and regions are schematically drawn in the drawings. Accordingly, the concept of the present disclosure is not limited by relative sizes or intervals drawn in the accompanying drawings.

Terms such as “first” and “second” are used herein merely to describe a variety of constituent elements, but the constituent elements are not limited by the terms. Such terms are used only for the purpose of distinguishing one constituent element from another constituent element. For example, without departing from the right scope of the disclosure, a first constituent element may be referred to as a second constituent element, and vice versa.

Terms used in the specification are used for explaining a specific embodiment, not for limiting the disclosure. Thus, an expression used in a singular form in the specification also includes the expression in its plural form unless clearly specified otherwise in context. Also, terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

Unless defined otherwise, all terms used herein including technical or scientific terms have the same meanings as those generally understood by those of ordinary skill in the art to which the disclosure may pertain. The terms as those defined in generally used dictionaries are construed to have meanings matching that in the context of related technology and, unless clearly defined otherwise, are not construed to be ideally or excessively formal.

When a certain embodiment may be implemented differently, a specific process order may be performed differently from the described order. For example, two consecutively described processes may be performed substantially at the same time or performed in an order opposite to the described order.

In the drawings, the illustrated shapes may be modified according to, for example, producing technology and/or tolerance. Thus, the embodiment of the disclosure may not be construed to be limited to a particular shape of a part described in the specification and may include a change in the shape generated during producing, for example. As used herein, the term “and/or” includes any and all combinations of one or more of the associated listed items. Furthermore, the term “substrate” used herein may mean a substrate by itself, or a stack structure including a substrate and a certain layer or film formed on a surface thereof. Furthermore, the term “surface of a substrate” used herein may mean an exposed surface of a substrate by itself, or an external surface such as a certain layer or film formed on the substrate.

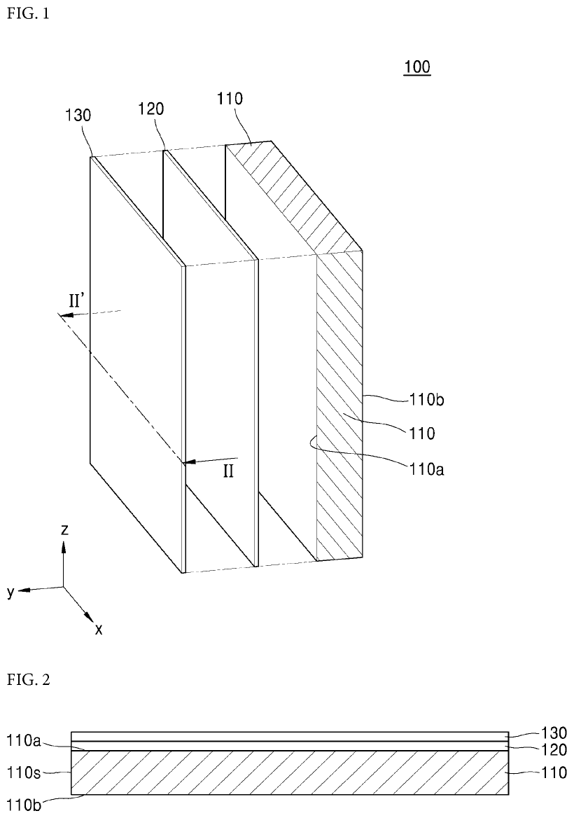

FIG. 1 is an exploded perspective view of a glass laminate article 100 according to an embodiment of the disclosure. FIG. 2 is a cross-sectional view taken along line II-II′ of the glass laminate article 100 of FIG. 1.

Referring to FIGS. 1 and 2, the glass laminate article 100 may include a core substrate 110, an adhesive member 120, and a glass substrate 130.

Core Substrate

The core substrate 110 may include a first surface 110a, a second surface 110b, and a side surface 110s extending between the first surface 110a and the second surface 110b. The first surface 110a and the second surface 110b, as two opposite main surfaces of the core substrate 110, may be surfaces that are substantially parallel to an x-z plane. Also, the side surface 110s may be a surface parallel to a y-axis between the first surface 110a and the second surface 110b.

In some embodiments, the core substrate 110 may include a metal substrate. The core substrate 110 may include, for example, aluminum (Al), an aluminum alloy, titanium (Ti), a titanium alloy, zinc (Zn), a zinc alloy, stainless steel, and the like.

In some embodiments, the core substrate 110 may include a polymer having a foam structure. The polymer having a foam structure may include polystyrene foam, polyethylene foam, polyurethane foam, polypropylene foam, and the like, but the disclosure is not limited thereto.

In some embodiments, the core substrate 110 may include a composite material of a metal oxide or a semimetal oxide. The semimetal oxide may include silica. The metal oxide may include titania, alumina, zirconia, or ceria.

The metal oxide or the semimetal oxide may have a powder form, and accordingly, to form the metal oxide or the semimetal oxide in the form of a panel, the metal oxide or the semimetal oxide may be bonded by using a binder.

The thermal transmittance of the core substrate 110 may be less than 20 W/m²K, less than 19 W/m²K, less than 18 W/m²K, less than 17 W/m²K, less than 16 W/m²K, less than 15 W/m²K, or less than 14 W/m²K, including all ranges and subranges therebetween.

In some embodiments, the thickness of the core substrate 110 may be, for example, about 0.5 mm to about 10 mm. In some embodiments, the thickness of the core substrate 110 may be about 1 mm to about 8 mm, about 1.5 mm to about 6 mm, or about 2 mm to about 4 mm, including all ranges and subranges therebetween.

In some embodiments, when the core substrate 110 is a metal substrate, the thickness of the core substrate 110 may be about 0.1 mm to about 0.8 mm, about 0.2 mm to about 0.7 mm, about 0.3 mm to about 0.6 mm, or about 0.4 mm to about 0.5 mm, including all ranges and subranges therebetween.

When the core substrate 110 is too thin, the thermal transmittance increases excessively, and thus the insulation effect may be insufficient. When the core substrate 110 is too thin, the volume and/or weight increases excessively, and thus the use of the glass laminate article 100 to which the core substrate 110 is applied may be limited.

The core substrate 110 does not include wood or a material derived from wood. For example, the core substrate 110 does not include articles produced of wood, wood particles, or wood fibers, such as, a medium density fiberboard (MDF), a high pressure laminate (HPL), a low density fiberboard (LDF), a high density fiberboard (HDF), or plywood.

Glass Substrate

The glass substrate 130 is provided above the first surface 110a of the core substrate 110. The glass substrate 130 may include aluminosilicate, alkali-aluminosilicate, borosilicate, alkali-borosilicate, aluminoborosilicate, alkali-aluminoborosilicate, soda lime, or other appropriate glasses. For example, commercial products such as EAGLE XG®, Lotus™, VVillow®, Iris™, or Gorilla® glasses produced by Corning Inc. may be used as the glass substrate 130.

Adhesive Member

The adhesive member 120 maybe provided between the first surface 110a of the core substrate 110 and the glass substrate 130. In some embodiments, the adhesive member 120 may bond the core substrate 110 and the glass substrate 130.

The adhesive member 120 may include ultraviolet curable (meth)acrylate resin. In some embodiments, the ultraviolet curable (meth)acrylate resin may include one or more selected from the group consisting of a polyurethane (meth)acrylate-base, a polyester (meth)acrylate-base, and an acryl (meth)acrylate-base.

In some embodiments, the adhesive member 120 may further include a segment derived from an acrylic monomer. For example, the acrylic monomer may include n-butyl (meth)acrylate, 2-butyl (meth)acrylate, t-butyl (meth)acrylate, isobutyl (meth)acrylate, hexyl (meth)acrylate, 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, 2-methylbutyl (meth)acrylate, n-nonyl (meth)acrylate, isononyl (meth)acrylate, isoamyl (meth)acrylate, n-decyl (meth)acrylate, isodecyl (meth)acrylate, isobornyl (meth)acrylate, 4-methyl-2-pentyl (meth)acrylate, 3,3,5-trimethyl cyclohexyl (meth)acrylate, dodecyl (meth)acrylate, lauryl (meth)acrylate, 2-ethoxyethyl (meth)acrylate, 2-methoxyethyl (meth)acrylate, allyl (meth)acrylate, or the like.

The adhesive member 120 may have a number-averaged molecular weight in a range of about 5,000 to about 3,000,000, about 6,000 to about 2,900,000, about 7,000 to about 2,800,000, about 8,000 to about 2,700,000, about 9,000 to about 2,600,000, about 10,000 to about 2,500,000, about 12,000 to about 2,400,000, about 14,000 to about 2,300,000, about 16,000 to about 2,200,000, about 18,000 to about 2,100,000, about 20,000 to about 2,000,000, or any range therebetween. The number-averaged molecular weight may be measured by a method, for example, gel permeation chromatography (GPC).

The adhesive member 120 may have an initial modulus in a range of about 10 MPa to about 300 M Pa, about 15 MPa to about 280 MPa, about 20 MPa to about 270 MPa, about 25 MPa to about 260 MPa, about 30 MPa to about 250 MPa, about 35 MPa to about 240 MPa, about 40 MPa to about 230 MPa, about 45 MPa to about 220 MPa, about 50 MPa to about 210 MPa, or any range therebetween.

The initial modulus is a value obtained by producing a cured specimen of the adhesive member 120 to have certain dimensions of, for example, 50 mm (length)×25 mm (width)×50 μm (thickness), obtaining a strain-stress curve, and then measuring an inclination in a deformation range of 0.5% to 1.0% thereof.

The adhesive member 120 may have a visible light transmittance of 90% or more and 100% or less, 91% or more and 100% or less, 92% or more and 100% or less, 93% or more and 100% or less, 94% or more and 100% or less, 95% or more and 100% or less, 96% or more and 100% or less, 97% or more and 100% or less, 98% or more and 100% or less, or 99% or more and 100% or less, or in any range between the above values. In some embodiments, when measured for a wavelength in the entire visible light range, the visible light transmittance may be 90% or more and 100% or less, 91% or more and 100% or less, 92% or more and 100% or less, 93% or more and 100% or less, 94% or more and 100% or less, 95% or more and 100% or less, 96% or more and 100% or less, 97% or more and 100% or less, 98% or more and 100% or less, or 99% or more and 100% or less, or in any range between the above values. In some embodiments, when measured for light having a wavelength of 380 nm to 780 nm, the visible light transmittance may be 90% or more and 100% or less, 91% or more and 100% or less, 92% or more and 100% or less, 93% or more and 100% or less, 94% or more and 100% or less, 95% or more and 100% or less, 96% or more and 100% or less, 97% or more and 100% or less, 98% or more and 100% or less, or 99% or more and 100% or less, or in any range between the above values. In some embodiments, when measured for light having a wavelength of 390 nm, 420 nm, 450 nm, 480 nm, 510 nm, 540 nm, 570 nm, 600 nm, 630 nm, 660 nm, 690 nm, 720 nm, 750 nm, and/or 780 nm, the visible light transmittance may be 90% or more and 100% or less, 91% or more and 100% or less, 92% or more and 100% or less, 93% or more and 100% or less, 94% or more and 100% or less, 95% or more and 100% or less, 96% or more and 100% or less, 97% or more and 100% or less, 98% or more and 100% or less, or 99% or more and 100% or less, or in any range between the above values.

The upper limit of the visible light transmittance of the adhesive member 120 may not be specified because a higher visible light transmittance is preferable.

The thickness of the adhesive member 120 may be about 0.01 μm to about 50 μm, about 0.02 μm to about 47 μm, about 0.04 μm to about 45 μm, about 0.06 μm to about 42 μm, about 0.08 μm to about 40 μm, about 0.1 μm to about 37 μm, about 0.12 μm to about 35 μm, about 0.14 μm to about 32 μm, or about 0.16 μm to about 30 μm, including all ranges and subranges therebetween.

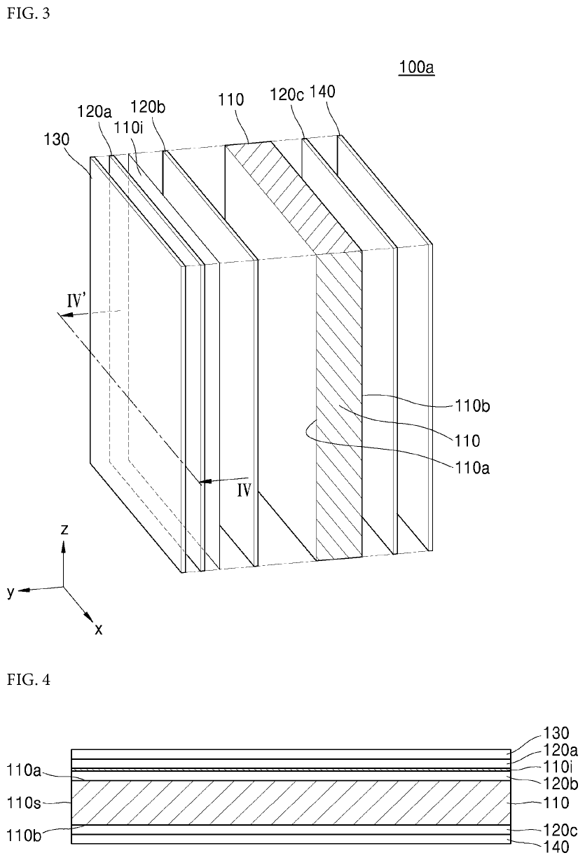

FIG. 3 is an exploded perspective view of a glass laminate article 100a according to another embodiment of the disclosure. FIG. 4 is a cross-sectional view taken along line IV-IV′ of the glass laminate article 100a of FIG. 3.

The glass laminate article 100a of FIG. 3 may be substantially the same as the glass laminate article 100 of FIG. 1, except that the glass laminate article 100a of FIG. 3 further includes an image layer 110i and a first metal layer 140. Accordingly, in the following description, such differences are mainly described and any redundant description thereof are omitted.

Referring to FIGS. 3 and 4, the glass laminate article 100a may further include the image layer 110i between the glass substrate 130 and the core substrate 110.

In some embodiments, the image layer 110i may include a pigment layer obtained by printing a pattern of a single color or two or more colors on a surface of the core substrate 110 by a method such as inkjet printing and the like.

In some embodiments, the image layer 110i may include a print film for printing an image and a pattern of a single color or two or more colors printed on the print film.

In some embodiments, the image layer 110i may include a metal layer and a pigment layer obtained by printing a pattern of a single color or two or more colors on the metal layer by a method such as inkjet printing and the like The metal layer may include Al, an aluminum alloy, Ti, a titanium alloy, Zn, a zinc alloy, stainless steel, and the like.

In some embodiments, the image layer 110i may include a metal layer and a print film bonded on the metal layer and on which a pattern of a single color or two or more colors is printed.

The print film may include a polypropylene (PP) film, a polyethylene terephthalate (PET) film, or a stack film thereof. The print film may include layers of other polymer resin in addition to the PP film and the PET film. For example, the print film may further include layers of other polymer resin including a polystyrene (PS), an acrylonitrile butadiene styrene (ABS) resin, high density polyethylene (HDPE), low density polyethylene (LDPE), polyvinyl chloride (PVC), polyethylene naphthalate, polybutylene terephthalate, polycarbonate (PC), or a copolymer thereof.

The thickness of the image layer 110i may be about 10 micrometer (μm) to about 400 μm, about 15 μm to about 370 μm, or about 20 μm to about 350 μm. When the image layer 110i is too thin, handling thereof may be difficult, and thus productivity may be reduced. When the image layer 110i is too thick, the thickness of the glass laminate article 100a becomes too thick, and thus it may be difficult to secure good appearance of a product.

When the image layer 110i is a pigment layer, the image layer 110i may be directly printed on the surface of the core substrate 110. When the image layer 110i is a print film on which an image is printed, the image layer 110i may be bonded on the glass substrate 130 via a first adhesive member 120a and on the first surface 110a of the core substrate 110 via a second adhesive member 120b. However, when the image layer 110i is a pigment layer that is printed on the surface of the core substrate 110 by a method such as inkjet printing and the like, the second adhesive member 120b may be omitted.

The first adhesive member 120a is the same as the adhesive member 120 of FIGS. 1 and 2, and additional descriptions thereof are omitted.

The first metal layer 140 may be further provided on the second surface 110b of the core substrate 110. A third adhesive member 120c may be further provided between the core substrate 110 and the first metal layer 140. The first metal layer 140 may be bonded on the core substrate 110 via the third adhesive member 120c.

The first metal layer 140 may include Al, an aluminum alloy, Ti, a titanium alloy, Zn, a zinc alloy, stainless steel, and the like.

In some embodiments, the thickness of the first metal layer 140 may be about 0.1 mm to about 0.8 mm. The thickness of the first metal layer 140 may be, for example, about 0.2 mm to about 0.7 mm, about 0.3 mm to about 0.6 mm, or about 0.4 mm to about 0.5 mm, including all ranges and subranges therebetween.

When the first metal layer 140 is too thin, strength is insufficient so as to be easily damaged, and thus it may be difficult to protect the core substrate 110. When the first metal layer 140 is too thick, the weight of a product increases, and thus the cost of a product may be increased.

In some embodiments, at least one of the second adhesive member 120b or the third adhesive member 120c is the same as the adhesive member 120 of FIGS. 1 and 2, and additional descriptions thereof are omitted.

In some embodiments, at least one of the second adhesive member 120b or the third adhesive member 120c may include, for example, a natural rubber adhesive composite, an α-olefin-based adhesive composite, a urethane resin-based adhesive composite, an ethylene-acetic acid vinyl resin emulsion adhesive composite, an ethylene-acetic acid vinyl resin-based hot melt adhesive composite, an epoxy resin-based adhesive composite, a vinyl chloride resin-based adhesive composite, a chloroprene rubber-based adhesive composite, a cyanoacrylate-based adhesive composite, a silicone-based adhesive composite, a styrene-butadiene rubber adhesive composite, a nitrile rubber-based adhesive composite, a nitrocellulose-based adhesive composite, a reactive hot melt adhesive composite, a phenol resin-based adhesive composite, a modified silicone-based adhesive composite, a polyester-based hot melt adhesive composite, a polyamide resin hot melt adhesive composite, a polyimide-based adhesive composite, a polyurethane resin hot melt adhesive composite, a polyolefin resin hot melt adhesive composite, a polyacetic acid vinyl resin-based adhesive composite, a polystyrene resin-based adhesive composite, a polyvinyl alcohol-based adhesive composite, a polyvinyl pyrrolidone resin-based adhesive composite, a polyvinyl bytyral-based adhesive composite, a polybenzimidazole adhesive composite, a polymethacrylate resin solvent-based adhesive composite, a melamine resin-based adhesive composite, a urea resin-based adhesive composite, a resorcinol-based adhesive composite, and the like. The above adhesive composite may be used alone or by mixing two or more composites.

The thickness of each of the second adhesive member 120b and the third adhesive member 120c may be independently about 0.01 μm to about 50 μm, about 0.02 μm to about 47 μm, about 0.04 μm to about 45 μm, about 0.06 μm to about 42 μm, about 0.08 μm to about 40 μm, about 0.1 μm to about 37 μm, about 0.12 μm to about 35 μm, about 0.14 μm to about 32 μm, or about 0.16 μm to about 30 μm, including all ranges and subranges therebetween.

In some embodiments, the third adhesive member 120c and the first metal layer 140 may be omitted.

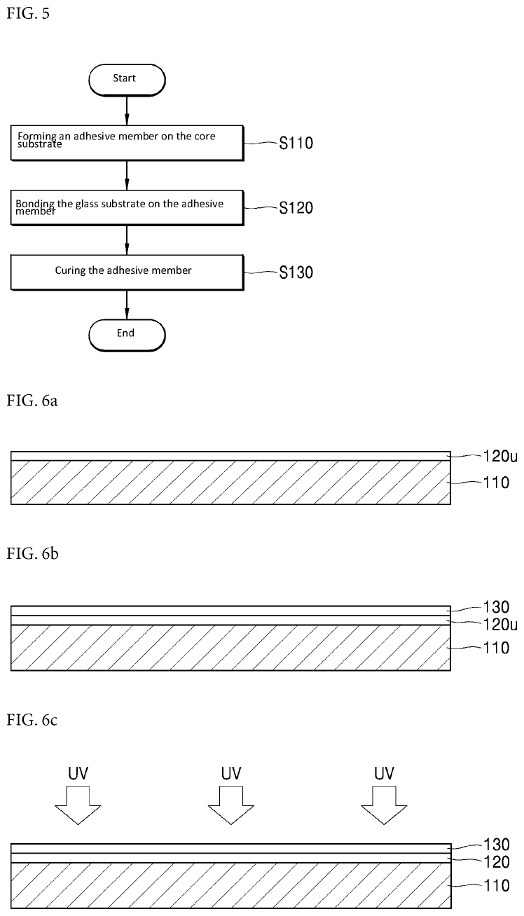

FIG. 5 is a flowchart showing a method of producing a glass laminate article, according to an embodiment of the disclosure. FIGS. 6A to 6C are cross-sectional views showing a method of producing a glass laminate article of FIG. 5.

Referring to FIGS. 5 and 6A, an adhesive member 120u that is not cured is formed on the core substrate 110 (S110).

As the adhesive member 120u is in an uncured state, the adhesive member 120u may have certain flowability. The adhesive member 120u may be formed by a method, for example, doctor blade, dip coating, gravure coating, slit die coating, spin coating, comma coating, bar coating, reverse roll coating, screen coating, cap coating, spray coating, electrostatic coating, and the like, but the disclosure is not limited thereto.

The adhesive member 120u may have an initial modulus of about 10 MPa to about 300 MPa at 25° C. after curing. As the method of measuring the initial modulus is described with reference to FIGS. 1 and 2, detailed descriptions thereof are omitted. In some embodiments, the adhesive member 120u after curing may have an initial modulus of about 15 MPa to about 280 MPa, about 20 MPa to about 270 MPa, about 25 MPa to about 260 MPa, about 30 MPa to about 250 MPa, about 35 MPa to about 240 MPa, about 40 MPa to about 230 MPa, about 45 MPa to about 220 MPa, about 50 MPa to about 210 MPa, or any range therebetween.

The glass transition temperature Tg of the adhesive member 120u may be about −30° C. to about 30° C. In some embodiments, the glass transition temperature Tg of the adhesive member 120u may be about −28° C. to about 29° C., about −26° C. to about 28° C., about −24° C. to about 27° C., about −22° C. to about 26° C., or about −20° C. to about 25° C., including all ranges and subranges therebetween. The glass transition temperature Tg may be measured by using, for example, differential scanning calorimetry (DSC).

The adhesive member 120u may be a mixture of an ultraviolet curable (meth)acrylate oligomer, a monofunctional or multifunctional acryl-based monomer, a photoinitiator, and an adhesion promotor.

[(Meth)Acrylate Oligomer]

The adhesive member 120u may include an ultraviolet curable (meth)acrylate oligomer. The ultraviolet curable (meth)acrylate oligomer may include one or more selected from the group consisting of a urethane (meth)acrylate-base, an ester (meth)acrylate-base, and an acryl (meth)acrylate-base.

The number-averaged molecular weight of the ultraviolet curable (meth)acrylate oligomer may be about 5,000 g/mol to about 300,000 g/mol, and the glass transition temperature Tg thereof may be about −30° C. to about 30° C. In some embodiments, the glass transition temperature Tg of the ultraviolet curable (meth)acrylate oligomer may be about −28° C. to about 29° C., about −26° C. to about 28° C., about −24° C. to about 27° C., about −22° C. to about 26° C., or about −20° C. to about 25° C., including all ranges and subranges therebetween.

Urethane (Meth)Acrylate Oligomer

In some embodiments, the urethane (meth)acrylate oligomer may be synthesized by reacting polyol and diisocyanate to obtain a compound containing an isocyanate group as an intermediate product, and reacting the compound containing an isocyanate group with (meth)acrylate containing a hydroxy group.

In some embodiments, the compound containing an isocyanate group may be obtained by reacting 1 equivalent of polyol with about 1 equivalent to 1.2 equivalents of diisocyanate.

In some embodiments, the polyol may include one homopolymer selected from the group consisting of polyester-based polyol, polyether-based polyol, polycarbonate-based polyol, polycaprolactam-based polyol, polytetrahydrofuran-based polyol, polypropylene-based polyol, and polyethylene-based polyol, two or more copolymers selected from the above group, or a mixture thereof.

In some embodiments, the diisocyanate may include one or two or more of, for example, isophorone diisocyanate, 2,4-toluenediisocyanate, 2,6-toluenediisocyanate, 1,4-butylenediisocyanate, 1,6-hexamethylenediisocyanate, lysine diisocyanate, trimethyl hexamethylene diisocyanate, 2,2-bis-4′-propaneisocyanate, 6-isopropyl-1,3-phenyldiisocyanate, bis(2-isocyanateethyl)-fumarate, 1,6-hexanediisocyanate, 4,4′-diphenylenediisocyanate, 3,3′-dimethylphenylenediisocyanate, 3,3′-dimethyl-4,4′-diphenylmethanediisocyanate, p-phenylene diisocyanate, m-phenylene diisocyanate, 1,4-naphthalenediisocyanate, 1,5-naphthalenediisocyanate, 1,4-xylenediisocyanate, 1,3-xylenediisocyanate, cyclopentylene-1,3-diisocyanate, 4,4′-dicyclohexylmethanediisocyanate, cyclohexene-1,4-diisocyanate, 4,4′-methylenebis(phenyl isocyanate), 2,2-diphenylpropane-4,4′-diisocyanate, azobenzene-4,4′-diisocyanate, tetramethylxylene diisocyanate, 1-chlorobenzene-2,4-diisocyanate, and the like.

In some embodiments, the (meth)acrylate containing a hydroxy group may be selected from the group consisting of, for example, 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, hydroxyalkylene glycol(meth)acrylate with 2-4 carbon atoms of an alkylene group, (meth)acryl acid, crotonic acid, maleic phosphoric acid, itaconic acid, fumaric acid, 3-(meth)acryloylpropionic acid, succinic anhydride ring-opening adduct of 2-hydroxyalkyl(meth)acrylate with 2-3 carbon atoms of an alkyl group, succinic anhydride ring opening adduct of hydroxyalkylene glycol(meth)acrylate with 2-4 carbon atoms of an alkylene group, and a compound obtained by ring-opening addition of succinic anhydride to a caprolactone adduct of 2-hydroxyalkyl(meth)acrylate having 2 to 3 carbon atoms of an alkyl group, and the like. However, the disclosure is not limited thereto.

Ester (Meth)Acrylate Oligomer

The ester (meth)acrylate-based oligomer resin may be prepared by any one of the following methods.

(Method A) First, polyester may be obtained by dehydration condensation reaction of polyhydric alcohol and polybasic acid (first operation), and polyester (meth)acrylate-based oligomer resin may be obtained by reacting the obtained polyester with one or more of (meth)acryl acid, hydroxyalkyl(meth)acrylate, and polyalkylene glycol (meth)acrylate (second operation). In some embodiments, the dehydration condensation reaction may be performed at a temperature of about 200° C. to about 260° C. and may be terminated before an acid value is increased to be greater than 10.

(Method B) Polyester (meth)acrylate-based oligomer resin may be obtained by integrally mixing and reacting polyhydric alcohol and polybasic acid with one or more of (meth)acryl acid, hydroxyalkyl(meth)acrylate, and polyalkylene glycol (meth)acrylate. In this state, the reaction may be performed in an atmosphere containing inert gas such as nitrogen and/or molecular oxygen to prevent gelation. In some embodiments, the reaction may be performed in an atmosphere containing air to prevent gelation.

An acid catalyst may be used in the second operation of the method A and the method B. The acid catalyst may include, for example, sulfuric acid, hydrochloric acid, phosphoric acid, paratoluene sulfone acid, benzene sulfone acid, methane sulfone acid, trifluoromethane sulfone acid, cation exchange resin, and the like, which may be used alone or in a combination of two or more.

The polyhydric alcohol may include, for example, glycerin, trimethylol ethane, trimethylol propane, pentaerythritol, diethylene glycol, neopentyl glycol, diglycerol, sorbitol, 1,6-hexanediol, and the like, which may be used alone or in a combination of two or more.

The polybasic acid may include an acid containing two or more carboxyl groups or derivatives thereof, for example, phthalic anhydride, phthalic acid, maleic phosphoric anhydride, maleic phosphoric acid, fumaric acid, adipic acid, isophthalic acid, benzoic acid, citric acid, lauryl acid, sebacic acid, oleic acid, and the like, which may be used alone or in a combination of two or more.

The addition amount of the polyhydric alcohol may be about 10 parts by weight to about 500 parts by weight, in particular, about 100 parts by weight to about 300 parts by weight, with respect to 100 parts by weight of the polybasic acid. Also, the addition amount of one or more of (meth)acryl acid, hydroxyalkyl(meth)acrylate, and polyalkylene glycol (meth)acrylate may be about 1 parts by weight to about 200 parts by weight, in particular, about 10 parts by weight to about 100 parts by weight, with respect to 100 parts by weight of the polybasic acid.

Acryl (Meth)Acrylate Oligomer

The acryl (meth)acrylate-based oligomer may be prepared by obtaining acryl polymer by polymerizing acryl monomers using a free radical initiator, and adding (meth)acryl acid or isocyanato(meth)acrylate thereto.

The acryl monomer may include (meth)acrylate of straight-chained, branched, or cyclic aliphatic alcohol with 1 to 40 carbon atoms, aromatic substituted (meth)acrylate, (meth)acrylate with 5 to 80 carbons with an ether group, (meth)acrylate containing hydroxy groups, or (meth)acrylate containing a biphenyl group.

The (meth)acrylate of straight-chained, branched, or cyclic aliphatic alcohol with 1 to 40 carbon atoms may include, for example, methyl (meth)acrylate, ethyl (meth)acrylate, n-butyl (meth)acrylate, isobutyl (meth)acrylate, tert-butyl (meth)acrylate, pentyl (meth)acrylate, 2-ethyl hexyl (meth)acrylate, stearyl (meth)acrylate, lauryl (meth)acrylate, cyclohexyl (meth)acrylate, isobornyl (meth)acrylate, and the like, but the disclosure is not limited thereto.

The aromatic substituted (meth)acrylate may include benzyl (meth)acrylate, phenyl (meth)acrylate, naphthyl (meth)acrylate, and the like, but the disclosure is not limited thereto.

The (meth)acrylate with 5 to 80 carbons with an ether group may include tetrahydrofurfuryl (meth)acrylate, methoxyethyl (meth)acrylate, ethoxyethyl (meth)acrylate, 1-butoxypropyl (meth)acrylate, cyclohexyloxymethyl (meth)acrylate, benzyloxymethyl (meth)acrylate, fufuryl (meth)acrylate, 2-butoxyethyl (meth)acrylate, 2-ethoxyethyl (meth)acrylate, allyloxymethyl (meth)acrylate, 1-ethoxybutyl (meth)acrylate, 1-ethoxyethyl (meth)acrylate, ethoxymethyl (meth)acrylate, poly(ethyleneglycol) methylether (meth)acrylate, poly(propyleneglycol) methylether (meth)acrylate, polyethylene glycol, polypropylene glycol, or a mixture thereof, and the like, but the disclosure is not limited thereto.

The (meth)acrylate containing a hydroxy group may be selected from the group consisting of, for example, 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, hydroxyalkylene glycol(meth)acrylate with 2-4 carbon atoms of an alkylene group, (meth)acryl acid, crotonic acid, maleic phosphoric acid, itaconic acid, fumaric acid, 3-(meth)acryloylpropionic acid, succinic anhydride ring-opening adduct of 2-hydroxyalkyl (meth) acrylate with 2-3 carbon atoms of an alkyl group, succinic anhydride ring opening adduct of hydroxyalkylene glycol(meth)acrylate with 2-4 carbon atoms of an alkylene group, and a compound obtained by ring-opening addition of succinic anhydride to a caprolactone adduct of 2-hydroxyalkyl(meth)acrylate having 2 to 3 carbon atoms of an alkyl group, and the like. However, the disclosure is not limited thereto.

The (meth)acrylate containing a biphenyl group may include, for example, o-biphenyl methacrylate, m-biphenyl methacrylate, p-biphenyl methacrylate, 2,6-terphenyl methacrylate, o-terphenyl methacrylate, m-terphenyl methacrylate, p-terphenyl methacrylate, 4-(4-methylphenyl)phenyl methacrylate, 4-(2-methylphenyl)phenyl methacrylate, 2-(4-methylphenyl)phenyl methacrylate, 2-(2-methylphenyl)phenyl methacrylate, 4-(4-ethylphenyl)phenyl methacrylate, 4-(2-ethylphenyl)phenyl methacrylate, 2-(4-ethylphenyl)phenyl methacrylate, 2-(2-ethylphenyl)phenyl methacrylate, and the like. However, the disclosure is not limited thereto.

The free radical initiator may include organic peroxide, hydroperoxide, persulfate, and an azo compound.

The free radical initiator may include, for example, methylethylketone peroxide, benzoyl peroxide, cumene hydroperoxide, potassium persulfate, azobisisobutyronitrile (AlBN), 2,5-dimethyl-2,5-di(t-butylperoxy)hexane, diethyl peroxide, di propyl peroxide, dilauryl peroxide, dioleil peroxide, distearyl peroxide, di(t-butyl)peroxide, di(t-amyl)peroxide, t-butyl hydroperoxide, t-amyl hydroperoxide, acetyl peroxide, propionyl peroxide, lauroyl peroxide, stearoyl peroxide, malonyl peroxide, succinyl peroxide, phthalyl peroxide, acetyl benzoyl peroxide, propionyl benzoyl peroxide, ascaridol, ammonium persulfate, sodium persulfate, sodium percarbonate, potassium percarbonate, sodium perborate, potassium perborate, sodium perphosphate, potassium perphosphate, tetralin hydroperoxide, t-butyl di perphthalate, t-butyl perbenzoate, 2,4-dichlorobenzoyl peroxide, urea peroxide, caprylyl peroxide, p-chlorobenzoyl peroxide, 2,2-bis(t-butylperoxy)) butane, hydroxyheptyl peroxide, or a mixture thereof. The content of the free radical initiator may be about 0.3 parts by weight to about 3 parts by weight, with respect to 100 parts by weight of the acryl monomer.

[Monofunctional or Multifunctional Acryl Monomer]

The adhesive member 120u may further include a monofunctional or multifunctional acryl monomer. In some embodiments, the adhesive member 120u may include about 100 parts by weight to about 400 parts by weight of the monofunctional or multifunctional acryl monomer, with respect to 100 parts by weight of ultraviolet curable (meth)acrylate oligomer.

The monofunctional or multifunctional acryl monomer may include one or two or more of n-butyl (meth)acrylate, 2-butyl (meth)acrylate, t-butyl (meth)acrylate, isobutyl (meth)acrylate, hexyl (meth)acrylate, 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, 2-methylbutyl (meth)acrylate, n-nonyl (meth)acrylate, isononyl (meth)acrylate, isoamyl (meth)acrylate, n-decyl (meth)acrylate, isodecyl (meth)acrylate, isobornyl (meth)acrylate, 4-methyl-2-pentyl (meth)acrylate, 3,3,5-trimethyl cyclohexyl (meth)acrylate, dodecyl (meth)acrylate, lauryl (meth)acrylate, 2-ethoxyethyl (meth)acrylate, 2-methoxyethyl (meth)acrylate, allyl (meth)acrylate, or the like. However, the disclosure is not limited thereto.

[Photoinitiator]

The adhesive member 120u may further include a photoinitiator.

The photoinitiator may include, for example, benzoin, benzoin methyl ether, benzoin ethyl ether, benzoin isopropyl ether, benzoin-n-butyl ether, benzoin isobutyl ether, acetophenone, hydroxy dimethyl acetophenone, dimethoxy-2-phenylacetophenone, 3-methylacetophenone, 2,2-dimethoxy-2-phenylacetophenone, 2,2-diethoxy-2-phenylacetophenone, 4-chronolocetophenone, 4,4-dimethoxyacetophenone, 2-hydroxy-2-methyl-1-phenyl propane-1-one, 4-hydroxycyclophenylketone, 1-hydroxycyclohexylphenylketone, 2-methyl-1-[4-(methylthio)phenyl]-2-morpholino-propane-1-one, 4-(2-hydroxyethoxy)phenyl-2-(hydroxy-2-propyl)ketone, benzophenone, p-phenyl benzophenone, 4,4-diamino benzophenone, 4,4′-diethylamino benzophenone, dichlorobenzophenone, anthraquinone, 2-methyl anthraquinone, 2-ethyl anthraquinone, 2-t-butyl anthraquinone, 2-amino anthraquinone, 2-methylthioxanthone, 2-ethylthioxanthone, 2-chlorothioxanthone, 2,4-dimethylthioxanthone, 2,4-diethylthioxanthone, benzyl dimethyl ketal, diphenyl ketone benzyl dimethyl ketal, acetophenone dimethyl ketal, p-dimethyl aminobenzoic acid ester, 2,4,6-trimethylbenzoyldiphenylphospinoxide, fluorene, triphenylamine, carbazole, and the like, which may be used alone or in a combination of two or more.

[Adhesion Promotor]

The adhesive member 120u may further include an adhesion promotor (coupling agent).

The adhesion promotor may include, for example, silane. In some embodiments, the adhesion promotor may include one or more selected from the group consisting of vinylchlorosilane, vinyltrimethoxysilane, vinyltriethoxysilane, 2-(3,4-epoxycyclohexyl)-ethyltrimethoxysilane, 3-glydoxypropyltrimethoxysilane, 3-glydoxypropylmethyldiethoxysilane, 3-glydoxypropyltriethylsilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanatopropyltriethoxysilane, and a mixture thereof.

Referring to FIGS. 5 and 6B, the glass substrate 130 is bonded on the adhesive member 120u (S120). As the glass substrate 130 is described with reference to FIGS. 1 and 2, any redundant description thereof is omitted.

To bond the glass substrate 130 to the adhesive member 120u, any method capable of allowing the glass substrate 130 to adhere well to the adhesive member 120u may be used. In some embodiments, the glass substrate 130 may be bonded to the adhesive member 120u by using a nip roller.

Referring to FIGS. 5 and 6C, the adhesive member 120u may be cured by applying light energy to the adhesive member 120u through the glass substrate 130 (S130).

As described above, as the adhesive member 120u is optical curable resin, the adhesive member 120u may be cured through the above-described light irradiation so as to become the adhesive member 120 that is cured. In some embodiments, the adhesive member 120u may be ultraviolet curable resin that is curable by an ultraviolet ray, and in this case, the light may be an ultraviolet ray (UV light).

The time for irradiating light onto adhesive member 120u may be about 10 seconds to about 40 seconds. In some embodiments, the time for irradiating light onto the adhesive member 120u may be about 15 seconds to about 38 seconds, about 18 seconds to about 35 seconds, or about 20 seconds to about 30 seconds.

Through the curing of the adhesive member 120u, the glass laminate article 100 as illustrated in FIG. 1 may be obtained.

Hereinafter, the configuration and effect of the present invention will be described in detail with specific embodiments and Comparative Examples, but these embodiments are merely for more clearly understanding the present invention and are not intended to limit the scope of the present invention.

### Production Example 1: Synthesis of Carbonate-Based Urethane Acrylate Oligomer

Under nitrogen atmosphere, 1 equivalent of polycarbonate-based polyol having a molecular weight of 1000 g/mol was input to a 4-neck separated reactor having a mechanical agitator with a stirring rod, a thermometer, and a reflux condenser, and the temperature of the inside of the reactor was slowly raised to about 50° C. When temperature control was stable, 1.05 equivalents of 1,6-hexamethylenediisocyanate was input and thus urethane reaction was first performed. In this state, as heat reaction occurred, the reaction was performed for about 4 hours, taking care that the temperature of the inside of the reactor does not exceed 75° C., and then 2-hydroxyethylacrylate was input according to the remaining NCO % and the reaction was further performed for about 2 hours, thereby finally obtaining carbonate-based urethane acrylate.

### Production Example 2: Synthesis of Carbonate-Based Urethane Acrylate Oligomer

Under a nitrogen atmosphere, 1 equivalent of polycarbonate-based polyol having a molecular weight of 2000 g/mol was input to the 4-neck separate reactor having a mechanical agitator with a stirring rod, a thermometer, and a reflux condenser, and the temperature of the inside of the reactor was slowly raised to about 50° C. When the temperature control was stable, 1.05 equivalents of 1,6-hexamethylenediisocyanate was input, and thus, urethane reaction was first performed. In this state, as heat reaction occurred, the reaction was performed for about 4 hours, taking care that the temperature of the inside of the reactor does not exceed 75° C., and then 2-hydroxyethylacrylate was input according to the remaining NCO % and the reaction was further performed for about 2 hours, thereby finally obtaining carbonate-based urethane acrylate.

### Production Example 3: Synthesis of Ester-Based Acrylate Oligomer

Under a nitrogen atmosphere, polyester polyol having a molecular weight of 1000 g/mol is first input for synthesis in a 4-neck reactor having a mechanical agitator with a stirring rod, a thermometer, a reflux condenser, and a distillation receiver. 0.4 equivalents of the synthesized polyester polyol ethylene glycol, 0.6 equivalents of 2-methyl-1,3-propanediol, 0.5 equivalents of adipic acid, and 0.5 equivalents of 1,4 cyclohexanedicarboxylic acid were input to the reactor and the reaction was performed at 200° C. to 250° C. to perform dehydration reaction, and then the reaction was terminated at an acid value 2 or less. Then, under a nitrogen atmosphere, 1 equivalent of the synthesized polyester-based polyol was input to the 4-neck separated reactor having a mechanical agitator with a stirring rod, a thermometer, and a reflux condenser, and the temperature of the inside of the reactor was slowly raised to about 50° C. When the temperature control was stable, 1.05 equivalents of 1,6-hexamethylenediisocyanate was input to the reactor to perform urethane reaction. In this state, as heat reaction occurred, the reaction was performed for about 4 hours, taking care that the temperature of the inside of the reactor does not exceed 75° C., and then 2-HEA was input according to the remaining NCO % and the reaction was further performed for about 2 hours, thereby finally obtaining ester-based urethane acrylate.

### Production Example 4: Synthesis of Ester-Based Acrylate Oligomer

Under a nitrogen atmosphere, polyester polyol having a molecular weight of 2000 g/mol is first input for synthesis to the 4-neck reactor having a mechanical agitator with a stirring rod, a thermometer, a reflux condenser, and a distillation receiver. 0.4 equivalents of the synthesized polyester polyol ethylene glycol, 0.6 equivalents of 2-methyl-1,3-propanediol, 0.5 equivalents of adipic acid, and 0.5 equivalent of 1,4 cyclohexanedicarboxylic acid were input to the reactor and the reaction was performed at 200° C. to 250° C. to perform dehydration reaction, and then the reaction was terminated at an acid value 2 or less. Then, under a nitrogen atmosphere, 1 equivalent of the synthesized polyester-based polyol was first input to the 4-neck separate reactor having a mechanical agitator with a stirring rod, a thermometer, and a reflux condenser, and the temperature of the inside of the reactor was slowly raised to about 50° C. When the temperature control was stable, 1.05 equivalents of 1,6-hexamethylenediisocyanate was input to the reactor to perform urethane reaction. In this state, as heat reaction occurred, the reaction was performed for about 4 hours, taking care that the temperature of the inside of the reactor does not exceed 75° C., and then 2-HEA was input according to the remaining NCO % and the reaction was further performed for about 2 hours, thereby finally obtaining ester-based urethane acrylate.

### Production Example 5: Synthesis of Acryl Acrylate Oligomer

45 parts by weight of acryl monomer isobornyl acrylate, 45 parts by weight of acryloyl morpholine acrylate, and 5 parts by weight of 4-hydroxy butyl acrylate were dropped into the 4-neck reactor having a mechanical agitator with a stirring rod, a thermometer, a reflux condenser, and a distillation receiver, by using 0.2 parts by weight of free radical for about 3 hours, and underwent growth reaction for about 3 hours (first reaction), and then, 5 parts by weight of 2-isocyanatoethyl acrylate was added (second reaction), thereby obtaining acryl acrylate oligomer.

### Production Example 6: Synthesis of Acryl Acrylate Oligomer

45 parts by weight of acryl monomer isobornyl acrylate, 45 parts by weight of acryloyl morpholine acrylate, 5 parts by weight of 4-hydroxy butyl acrylate were dropped into the 4-neck reactor having a mechanical agitator with a stirring rod, a thermometer, a reflux condenser, and a distillation receiver, by using 0.1 parts by weight of free radical for about 3 hours, and underwent growth reaction for about 3 hours (first reaction), and then, 5 parts by weight of 2-isocyanatoethyl acrylate was added (second reaction), thereby obtaining acryl acrylate oligomer.

### Production Example 7: Synthesis of Acryl Acrylate Oligomer

45 parts by weight of acryl monomer isobornyl acrylate, 45 parts by weight of acryloyl morpholine acrylate, and 5 parts by weight of glycidyl methacrylate were dropped into the 4-neck reactor having a mechanical agitator with a stirring rod, a thermometer, a reflux condenser, and a distillation receiver, by using 0.2 parts by weight of free radical for about 3 hours, and underwent growth reaction for about 3 hours (first reaction), and then, 5 parts by weight of acryl acid was added (second reaction), thereby obtaining acryl acrylate oligomer.

### Embodiment 1

30 g of the carbonate-based urethane acrylate oligomer synthesized in Production Example 1, 35 g of isobornyl acrylate, 33.5 g of tetrahydrofurfuryl acrylate, 0.5 g of adhesion promotor, and 1 g of a photoinitiator, with a total weight of 100 g, were input to a blender capable of agitating, and agitated and mixed at room temperature for 15 minutes at 500 rpm. Then, a UV curable resin composite was obtained through filtering using a 200 mesh filter.

### Embodiment 2

30 g of the carbonate-based urethane acrylate oligomer synthesized in Production Example 2, 35 g of isobornyl acrylate, 33.5 g of tetrahydrofurfuryl acrylate, 0.5 g of adhesion promotor, and 1 g of a photoinitiator, with a total weight of 100 g, were input to the blender capable of agitating, and agitated and mixed at room temperature for 15 minutes at 500 rpm. Then, a UV curable resin composite was obtained through filtering using a 200 mesh filter.

### Embodiment 3

30 g of the ester-based acrylate oligomer synthesized in Production Example 3, 35 g of isobornyl acrylate, 33.5 g of tetrahydrofurfuryl acrylate, 0.5 g of adhesion promotor, and 1 g of a photoinitiator, with a total weight of 100 g, were input to the blender capable of agitating, and agitated and mixed at room temperature for 15 minutes at 500 rpm. Then, a UV curable resin composite was obtained through filtering using a 200 mesh filter.

### Embodiment 4

30 g of the ester-based acrylate oligomer synthesized in Production Example 4, 35 g of isobornyl acrylate, 33.5 g of tetrahydrofurfuryl acrylate, 0.5 g of adhesion promotor, and 1 g of a photoinitiator, with a total weight of 100 g, were input to the blender capable of agitating, and agitated and mixed at room temperature for 15 minutes at 500 rpm. Then, a UV curable resin composite was obtained through filtering using a 200 mesh filter.

### Embodiment 5

30 g of the carbonate-based urethane acrylate oligomer synthesized in Production Example 1, 35 g of isobornyl acrylate, 33.5 g of 2-hydroxy ethylacrylate, 0.5 g of adhesion promotor, and 1 g of a photoinitiator, with a total weight of 100 g, were input to the blender capable of agitating, and agitated and mixed at room temperature for 15 minutes at 500 rpm. Then, a UV curable resin composite was obtained through filtering using a 200 mesh filter.

### Embodiment 6

30 g of the carbonate-based urethane acrylate oligomer synthesized in Production Example 2, 35 g of isobornyl acrylate, 33.5 g of 2-hydroxy ethylacrylate, 0.5 g of adhesion promotor, and 1 g of a photoinitiator, with a total weight of 100 g, were input to the blender capable of agitating, and agitated and mixed at room temperature for 15 minutes at 500 rpm. Then, a UV curable resin composite was obtained through filtering using a 200 mesh filter.

### Embodiment 7

30 g of the ester-based acrylate oligomer synthesized in Production Example 3, 35 g of isobornyl acrylate, 33.5 g of 2-hydroxy ethylacrylate, 0.5 g of adhesion promotor, and 1 g of a photoinitiator, with a total weight of 100 g, were input to the blender capable of agitating, and agitated and mixed at room temperature for 15 minutes at 500 rpm. Then, a UV curable resin composite was obtained through filtering using a 200 mesh filter.

### Embodiment 8

30 g of the ester-based acrylate oligomer synthesized in Production Example 4, 35 g of isobornyl acrylate, 33.5 g of 2-hydroxy ethylacrylate, 0.5 g of adhesion promotor, and 1 g of a photoinitiator, with a total weight of 100 g, were input to the blender capable of agitating, and agitated and mixed at room temperature for 15 minutes at 500 rpm. Then, a UV curable resin composite was obtained through filtering using a 200 mesh filter.

### Embodiment 9

30 g of the acryl acrylate oligomer synthesized in Production Example 5, 35 g of isobornyl acrylate, 33.5 g of tetrahydro fufuryl acrylate, 0.5 g of adhesion promotor, and 1 g of a photoinitiator, with a total weight of 100 g, were input to in the blender capable of agitating, and agitated and mixed at room temperature for 15 minutes at 500 rpm. Then, a UV curable resin composite was obtained through filtering using a 200 mesh filter.

### Embodiment 10

30 g of the acryl acrylate oligomer synthesized in Production Example 6, 35 g of isobornyl acrylate, 33.5 g of tetrahydro fufuryl acrylate, 0.5 g of adhesion promotor, and 1 g of a photoinitiator, with a total weight of 100 g, were input to the blender capable of agitating, and agitated and mixed at room temperature for 15 minutes at 500 rpm. Then, a UV curable resin composite was obtained through filtering using a 200 mesh filter.

### Embodiment 11

30 g of the acryl acrylate oligomer synthesized in Production Example 7, 35 g of isobornyl acrylate, 33.5 g of tetrahydro fufuryl acrylate, 0.5 g of adhesion promotor, and 1 g of a photoinitiator, with a total weight of 100 g, were input to the blender capable of agitating, and agitated and mixed at room temperature for 15 minutes at 500 rpm. Then, a UV curable resin composite was obtained through filtering using a 200 mesh filter.

### Comparative Example 1

30 g of a commercial acrylate-based oligomer (produced by Miwon Specialty Chemical Co., Ltd., PU2560), 35 g of isobornyl acrylate, 33.5 g of tetrahydro fufuryl acrylate, 0.5 g of adhesion promotor, and 1 g of a photoinitiator, with a total weight of 100 g, were input to the blender capable of agitating, and agitated and mixed at room temperature for 15 minutes at 500 rpm. Then, a UV curable resin composite was obtained through filtering using a 200 mesh filter.

### Comparative Example 2

30 g of the commercial acrylate-based oligomer (produced by Miwon Specialty Chemical Co., Ltd., PU2500), 35 g of isobornyl acrylate, 33.5 g of tetrahydro fufuryl acrylate, 0.5 g of adhesion promotor, and 1 g of a photoinitiator, with a total weight of 100 g, were input to the blender capable of agitating, and agitated and mixed at room temperature for 15 minutes at 500 rpm. Then, a UV curable resin composite was obtained through filtering using a 200 mesh filter.

### Comparative Example 3

30 g of the commercial acrylate-based oligomer (produced by Miwon Specialty Chemical Co., Ltd., PU2560), 35 g of isobornyl acrylate, 33.5 g of 2-hydroxy ethylacrylate, 0.5 g of adhesion promotor, and 1 g of a photoinitiator, with a total weight of 100 g, were input to the blender capable of agitating, and agitated and mixed at room temperature for 15 minutes at 500 rpm. Then, a UV curable resin composite was obtained through filtering using a 200 mesh filter.

### Comparative Example 4

30 g of the commercial acrylate-based oligomer (produced by Miwon Specialty Chemical Co., Ltd., PU2500), 35 g of isobornyl acrylate, 33.5 g of 2-hydroxy ethylacrylate, 0.5 g of adhesion promotor, and 1 g of a photoinitiator, with a total weight of 100 g, were input to the blender capable of agitating, and agitated and mixed at room temperature for 15 minutes at 500 rpm. Then, a UV curable resin composite was obtained through filtering using a 200 mesh filter.

TABLE 1

| | Embodiment | | | | | | | | | | | Comparative Example | | | |
|---|---|---|---|---|---|---|---|---|---|---|---|---|---|---|---|
| | 1 | 2 | 3 | 4 | 5 | 6 | 7 | 8 | 9 | 10 | 11 | 1 | 2 | 3 | 4 |
| PU2560 | | | | | | | | | | | | 30 | | 30 | |
| PU2500 | | | | | | | | | | | | | 30 | | 30 |
| Production Example 1 | 30 | | | | 30 | | | | | | | | | | |
| Production Example 2 | | 30 | | | | 30 | | | | | | | | | |
| Production Example 3 | | | 30 | | | | 30 | | | | | | | | |
| Production Example 4 | | | | 30 | | | | 30 | | | | | | | |
| Production Example 5 | | | | | | | | | 30 | | | | | | |
| Production Example 6 | | | | | | | | | | 30 | | | | | |
| Production Example 7 | | | | | | | | | | | 30 | | | | |
| ISOBORNYL ACRYLATE | 35 | 35 | 35 | 35 | 35 | 35 | 35 | 35 | 35 | 35 | 35 | 35 | 35 | 35 | 35 |
| TETRAHYDRO FUFURYL | 33.5 | 33.5 | 33.5 | 33.5 | | | | | 33.5 | 33.5 | 33.5 | 33.5 | 33.5 | | |
| ACRYLATE | | | | | | | | | | | | | | | |
| 2-HYDROXY ETHYLACRYLATE | | | | | 33.5 | 33.5 | 33.5 | 33.5 | | | | | | 33.5 | 33.5 |
| ADHESION PROMOTOR | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| INITIATOR | 1 | 1 | 1 | 1 | 1 | 1 | 1 | 1 | 1 | 1 | 1 | 1 | 1 | 1 | 1 |

(in PARTS BY WEIGHT)

A layer of a UV curable resin composite having a composition of Embodiments 1 to 11 and Comparative Examples 1 to 4 was formed to a 25 μm thickness on a PET-coated steel plate having a 0.5 mm thickness as a core substrate, and a glass substrate having a 0.3 mm thickness was stacked thereon by applying a pressure of 2.5 kg thereto by using a hand roller. Then, UV light was irradiated by using a UV irradiator to cure the UV curable resin composite. In this state, UVA of the UV light was 1000 mJ/cm², and UVB thereof was 800 mJ/cm².

Adhesion, transparency, yellowing, and weather resistance were examined for each cured specimen, and results thereof were summarized in Table 2. A detailed method of evaluating the properties is as follows.

Adhesion Evaluation

Adhesion was examined by sensory evaluation. Adhesion strength was evaluated, through sensory evaluation, in the following four levels.
⊚: Very Good: A level of glass breakage without delamination of a bonded portion
◯: Good: A level of glass breakage with partial delamination at the edge of a bonded portion
Δ: Partly Bad: A level of no glass breakage with slow delamination of a bonded portion
X: Bad: A level of easy delamination

Transparency Evaluation

Transmittance (%) was measured by using BYK Haze-gard plus equipment, and when transmittance is 90% or more, it was determined to be good (◯), and when the transmittance is less than 90%, it was determined to be bad (X).

Yellowing Evaluation

A degree of yellowing was measured by irradiating UVA at 30,000 mJ/cm² by using Color-Eye 7000A equipment by GretagMacbeth, and evaluated in the following four levels.
⊚: Very Good: A level of no difference before and after UV curing
◯: Good: A level of occurrence of slight yellowing, but no problem in appearance
Δ: Partly Bad: A level of occurrence of severe yellowing with problem in appearance
X: Bad: A level of occurrence of very severe yellowing

Weather Resistance Evaluation

The cured specimens were left at constant temperature and constant humidity conditions of 85° C. and relative humidity 85% for 720 hours, and whether a lift-off portion is generated and whether delamination has occurred were evaluated in the following four levels.
⊚: Very Good: A level of no lift-off of a bonded portion occurred after TEST, and glass breakage without delamination during a delamination test
◯: Good: A level of no lift-off of a bonded portion occurred after TEST, and glass breakage with slight delamination during a delamination test
Δ: Partly Bad: A level of a lift-off occurred partially after 720 hours pass at the constant temperature and constant humidity condition
X: Bad: A level of a lift-off in a coin size or more before 720 hours pass at the constant temperature and constant humidity condition

TABLE 2

| | Embodiment | | | | | | | | | | | Comparative Example | | | |
|---|---|---|---|---|---|---|---|---|---|---|---|---|---|---|---|
| | 1 | 2 | 3 | 4 | 5 | 6 | 7 | 8 | 9 | 10 | 11 | 1 | 2 | 3 | 4 |
| ADHESION | ◯ | ⊚ | ◯ | ⊚ | ◯ | ⊚ | ◯ | ⊚ | Δ | Δ | ⊚ | ◯ | ◯ | ◯ | ◯ |
| TRANSPARENCY | ◯ | ◯ | ◯ | ◯ | ◯ | ◯ | ◯ | ◯ | ◯ | ◯ | ◯ | ◯ | ◯ | ◯ | ◯ |
| YELLOWING | ⊚ | ◯ | ◯ | ◯ | ⊚ | ◯ | ◯ | ◯ | ◯ | ◯ | ◯ | ◯ | ◯ | ◯ | ◯ |
| WEATHER | ⊚ | ⊚ | ◯ | ◯ | ⊚ | ⊚ | ◯ | ◯ | ◯ | ◯ | ◯ | X | X | Δ | Δ |
| RESISTANCE | | | | | | | | | | | | | | | |

As shown in Table 2, there was generally no difference in transparency and yellowing, but there was a difference in adhesion and weather resistance. It was seen that a specimen produced of a UV curable resin composite having compositions of Embodiment 5 and Embodiment 6 exhibits more excellent properties in terms of adhesion and weather resistance.

Glass laminate articles of GoS, GoHPL, and GoSoMDF were produced by using UV curable resin of Embodiments 1, 6, and 10 and Comparative Examples 1 and 3. Also, glass laminate articles of GoS, GoHPL, and GoSoMDF were produced by using UV curable resin (Henkel 3311) by Henkel that is commercially available (Comparative Example 5).

Here, GoS denotes a products in which glass is bonded to a steel substrate using the UV curable resin, GoHPL denotes a product in which glass is bonded to a high pressure laminate (HPL) substrate using the UV curable resin, and GoSoMDF denotes a product in which a steel substrate is bonded to a medium density fiberboard (MDF), and glass is bonded thereto using the UV curable resin.

Corning Environment Evaluations #1 to #4 were performed on each of the produced products. Details of Corning Environment Evaluations #1 to #4 are as follows.

TABLE 3

| | ENVIRONMENTAL CONDITIONS |
|---|---|
| #1 | KEEP AT 60° C. FOR 7 DAYS |
| #2 | KEEP AT 30° C. AND RELATIVE HUMIDITY OF 90% FOR |
| | 7 DAYS |
| #3 | KEEP AT 30° C. AND RELATIVE HUMIDITY OF 30% FOR |
| | 7 DAYS |
| #4 | REPEAT 14 TIMES CYCLE OF KEEPING AT 60° C. FOR |
| | 11 HOURS → DECREASING TEMPERATURE TO −40° C. FOR |
| | 1 HOUR → KEEPING AT −40° C. FOR 11 HOURS → |
| | INCREASING TEMPERATURE TO 60° C. FOR 1 HOUR |

After Corning Environment Evaluations #1 to #4 were performed, when delamination or breakage of glass occurred, it was determined to be Fail, and when no delamination or breakage of glass occurred, it was determined to be Pass.

Also, to measure the initial modulus, a specimen of a UV curable resin composite was produced to have dimensions of 50 mm (length)×25 mm (width)×50 μm (thickness), and a strain-stress curve was obtained through UTM measurement. An inclination in a deformation range of 0.5% to 1.0% thereof was measured. As a result, a result as shown in Table 4 was obtained.

TABLE 4

| | | | | Modulus |
|---|---|---|---|---|
| UV resin | GoS | GoHPL | GoSoMDF | (MPa) |
| Embodiment 1 | Pass | Pass | Pass | 206.8 |
| Embodiment 6 | Pass | Pass | Pass | 155 |
| Embodiment 10 | Pass | Pass | Pass | 60 |
| Comparative Example 1 | Pass | Fail | Fail | 535.6 |
| Comparative Example 3 | Pass | Fail | Fail | 362.7 |
| Comparative Example 5 | Fail | Fail | Fail | 2299.4 |

Referring to Table 4, when the initial modulus of UV curable resin is less than 250 MPa, all products passed Corning Environment Evaluations #1 to #4. In contrast, when the initial modulus of UV curable resin exceeds 250 MPa, some or all products did not pass Corning Environment Evaluations #1 to #4.

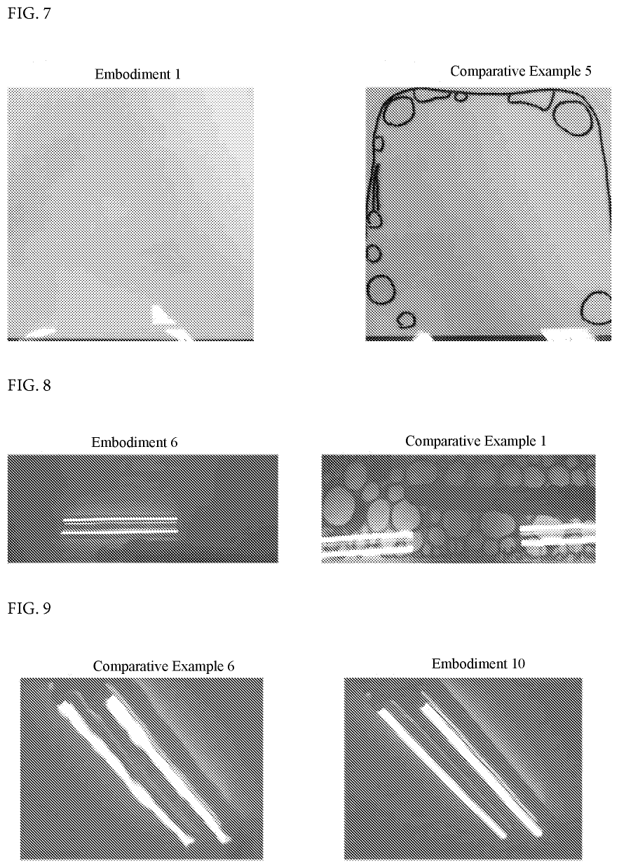

FIG. 7 shows images according to results of Corning Environment Evaluation #5 performed on GoS products produced by using the UV curable resin of Embodiment 1 and Comparative Example 5. Corning Environment Evaluation #5 is an environment of keeping at a temperature of 85° C. and a relative humidity of 85% for 7 days.

As illustrated in FIG. 7, in a GoS product produced of the UV curable resin of Comparative Example 5 in which the initial modulus exceeds 250 MPa, delamination occurred in various ranges (indicated by a block line) by Corning Environment Evaluation #5. In contrast, in a GoS product produced of the UV curable resin of Embodiment 1 in which the initial modulus is less than 250 MPa, delamination did not occur at all even after Corning Environment Evaluation #5 was performed.

FIG. 8 shows images according to results of Corning Environment Evaluation #4 performed on GoHPL products produced by using the UV curable resin of Embodiment 6 and Comparative Example 1.

As illustrated in FIG. 8, in a GoHPL product produced of the UV curable resin of Comparative Example 1 in which the initial modulus exceeds 250 MPa, delamination occurred in various ranged by Corning Environment Evaluation #4. In contrast, in a GoS product produced of the UV curable resin of Embodiment 6 in which the initial modulus is less than 250 MPa, delamination did not occur at all even after Corning Environment Evaluation #5 was performed.

FIG. 9 shows images according to results of Corning Environment Evaluations #1 to #4 performed on a GoSoMDF product produced by using the UV curable resin of Embodiment 10 and a GoSoMDF product (Comparative Example 6) to which a glass substrate is bonded by using OCA instead of the UV curable resin.

Referring to FIG. 9, no delamination occurred in the product of Comparative Example 6 produced by using OCA, even after Corning Environment Evaluations #1 to #4 were performed. However, in the product of Comparative Example 6, an image distortion phenomenon that a straight light source is reflected to be bent was severe.

In contrast, it was checked that, in the product of Embodiment 10, not only that delamination did not occur after Corning Environment Evaluations #1 to #4 were performed, but also that the straight light source is reflected as it is, and thus, there is no image distortion phenomenon.

When the glass laminate article and the adhesive composition for a glass laminate article according to the present disclosure are used, there are effects of preventing delamination of glass and maintaining a high level of flatness.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A glass laminate article comprising:
a resin layer provided on a first surface of a core substrate; and
a glass substrate layer provided on the resin layer,
wherein the resin layer has an initial modulus of 30 MPa to 250 MPa, the initial modulus being measured in a deformation range of 0.5% to 1.0%.

2. The glass laminate article of claim 1, wherein
the resin layer comprises ultraviolet curable (meth)acrylate resin having a number-averaged molecular weight of 5,000 to 3,000,000.

3. The glass laminate article of claim 1, wherein
the resin layer comprises a polymerization product of an ultraviolet curable (meth)acrylate oligomer and a monofunctional or multifunctional acryl monomer,
the ultraviolet curable (meth)acrylate oligomer is urethane (meth)acrylate based, and the urethane (meth)acrylate-based oligomer is produced by
obtaining an isocyanate group-containing compound by reacting polyol with diisocyanate in an equivalent ratio of 1:1 to 1:1.2, and
reacting the isocyanate group-containing compound with (meth)acrylate containing a hydroxy group.

4. The glass laminate article of claim 1, wherein
the resin layer comprises a polymerization product of an ultraviolet curable (meth)acrylate oligomer and a monofunctional or multifunctional acryl monomer,
the ultraviolet curable (meth)acrylate oligomer is ester (meth)acrylate based, and the ester (meth)acrylate-based oligomer is produced by
obtaining polyester by a dehydration and condensation reaction of polyhydric alcohol and polybasic acid, and
reacting the polyester with at least one of (meth)acryl acid, hydroxyalkyl(meth)acrylate, and polyalkylene glycol mono(meth)acrylate.

5. The glass laminate article of claim 1, wherein
the resin layer comprises a polymerization product of an ultraviolet curable (meth)acrylate oligomer and a monofunctional or multifunctional acryl monomer,
the ultraviolet curable (meth)acrylate oligomer is ester (meth)acrylate-based, and the ester (meth)acrylate-based oligomer is produced by
mixing and reacting polyhydric alcohol and polybasic acid with at least one of (meth)acryl acid, hydroxyalkyl(meth)acrylate, and polyalkylene glycol mono(meth)acrylate.

6. The glass laminate article of claim 1, wherein
the resin layer comprises a polymerization product of an ultraviolet curable (meth)acrylate oligomer and a monofunctional or multifunctional acryl monomer,
the ultraviolet curable (meth)acrylate oligomer is acryl (meth)acrylate-based, and the acryl (meth)acrylate-based oligomer is produced by
obtaining an acryl polymer by polymerizing acryl monomers, and adding (meth)acryl acid or isocyanato(meth)acrylate to the acryl polymer.

7. The glass laminate article of claim 1, wherein
visible light transmittance of the resin layer is 90% or more.

8. The glass laminate article of claim 1, further comprising
a first metal layer on a second surface opposite to the first surface of the core substrate.

9. A glass laminate article comprising:
a core substrate comprising a first surface, a second surface opposite to the first surface, and a side surface between the first surface and the second surface;
a glass substrate provided on the first surface;
an image layer between the first surface and the glass substrate; and
an adhesive member provided between the glass substrate and the image layer,
wherein the adhesive member comprises ultraviolet curable (meth)acrylate resin, and
the ultraviolet curable (meth)acrylate resin is one or more selected from the group consisting of polyurethane (meth)acrylate, polyester (meth)acrylate, and polyacryl (meth)acrylate and has a number-averaged molecular weight of 5,000 to 3,000,000.

10. The glass laminate article of claim 9, wherein
an initial modulus of the adhesive member is 30 MPa to 250 MPa.

11. The glass laminate article of claim 10, wherein
the image layer comprises a metal layer.

12. The glass laminate article of claim 10, wherein
the polyurethane (meth)acrylate comprises a polymerization product of a urethane (meth)acrylate oligomer and a monofunctional or multifunctional acryl monomer.

13. The glass laminate article of claim 10, wherein
the polyester (meth)acrylate comprises a polymerization product of an ester (meth)acrylate oligomer and a monofunctional or multifunctional acryl monomer.

14. The glass laminate article of claim 10, wherein
the polyacryl (meth)acrylate comprises a polymerization product of an acryl (meth)acrylate oligomer and a monofunctional or multifunctional acryl monomer.

15. The glass laminate article of claim 12, wherein
the monofunctional or multifunctional acryl monomer is one or more selected from the group consisting of n-butyl (meth)acrylate, 2-butyl (meth)acrylate, t-butyl (meth)acrylate, isobutyl (meth)acrylate, hexyl (meth)acrylate, 2-ethylhexyl (meth)acrylate, ethyl (meth) acrylate, methyl (meth)acrylate, n-propyl (meth)acrylate, isopropyl (meth)acrylate, pentyl (meth)acrylate, n-octyl (meth)acrylate, isooctyl (meth)acrylate, 2-methylbutyl (meth)acrylate, n-nonyl (meth)acrylate, isononyl (meth)acrylate, isoamyl (meth)acrylate, n-decyl (meth)acrylate, isodecyl (meth)acrylate, isobornyl (meth)acrylate, 4-methyl-2-pentyl (meth)acrylate, 3,3,5-trimethyl cyclohexyl (meth)acrylate, dodecyl (meth)acrylate, lauryl (meth)acrylate, 2-ethoxyethyl (meth)acrylate, 2-methoxyethyl (meth)acrylate, and allyl (meth)acrylate.

16. An adhesive composition for a glass laminate article, the adhesive composition comprising:
100 parts by weight of an ultraviolet curable (meth)acrylate oligomer having a number-averaged molecular weight of 5,000 to 300,000;
100 parts by weight to 400 parts by weight of a monofunctional or multifunctional acryl monomer;
1 part by weight to 5 parts by weight of a photoinitiator; and
0.5 parts by weight to 3 parts by weight of an adhesion promotor,
wherein the adhesive composition has a glass transition temperature (Tg) of −30° C. to 30° C., visible light transmittance of 90% or more, and an initial modulus of 10 MPa to 300 MPa when measured in a deformation range of 0.5% to 1.0% after cured by ultraviolet irradiation.
